(19) United States
(12) Patent Application Publication
(10) Pub. No.: US 2014/0041846 A1
(43) Pub. Date: Feb. 13, 2014

(54) HVAC SYSTEM WITH MULTIPLE EQUIPMENT INTERFACE MODULES

(71) Applicants: Cary Leen, Hammond, WI (US); Stan Zywicki,, III, Eden Prairie, MN (US); Steve C. Nichols, Plymouth, MN (US)

(72) Inventors: Cary Leen, Hammond, WI (US); Stan Zywicki,, III, Eden Prairie, MN (US); Steve C. Nichols, Plymouth, MN (US)

(73) Assignee: HONEYWELL INTERNATIONAL INC., Morristown, NJ (US)

(21) Appl. No.: 13/571,017

(22) Filed: Aug. 9, 2012

(51) Int. Cl. G05D 23/19; F24F 11/00; F25D 21/06; F24F 3/00; F24F 11/04

(52) U.S. Cl. 165/208; 236/1 C; 165/244; 62/151

(57) ABSTRACT

An HVAC system may include a building controller, two or more HVAC components and at least two Equipment Interface Modules (EIM). Each of the EIMs may include a wired and/or wireless interface for communication to the HVAC controller. Each EIM may be wired to one or more of the HVAC components of the HVAC system. In some cases, the HVAC controller may be configured to provide one or more control commands to control two or more of the HVAC components of the HVAC system via the EIMs. In some cases, the EIMs may provide control signals to the HVAC controller, and the HVAC controller may generate one or more commands in response to the received control signals.

### TECHNICAL FIELD

The present disclosure relates generally to HVAC systems, and more particularly, to systems and methods for controlling HVAC systems.

### BACKGROUND

Heating, ventilation, and/or air conditioning (HVAC) systems are used to control the comfort level within a building or other structure. Such HVAC systems typically include an HVAC controller that controls various HVAC components of the HVAC system in order to affect and/or control one or more environmental conditions within the building.

### SUMMARY

The present disclosure relates generally to HVAC systems, and more particularly, to systems and methods for controlling HVAC systems.

In one illustrative embodiment, an HVAC controller such as a thermostat may be used to control an HVAC system having two or more HVAC components via at least two Equipment Interface Modules (EIM). Each of the Equipment Interface Modules (EIM) may include a wireless interface for communicating with the HVAC controller. Each EIM may be wired to one or more different HVAC components within the HVAC system. In some cases, the HVAC controller may include a user interface having a display, a controller coupled to the user interface, two or more control terminals for optionally interfacing with one or more HVAC components via control wires, and a wireless interface coupled to the controller for wirelessly interfacing with one or more HVAC components via one or more wireless EIMs that are connected to the HVAC components.

In some instances, a first EIM may be connected to a first HVAC component and a second EIM may be connected to a second HVAC component. In some cases, the first HVAC component may be located in a physically separate location from the second HVAC component, but this is not required. For example, the first HVAC component may be in the attic and the second HVAC component may be in the basement of a building. The HVAC controller may be configured to provide one or more control commands for controlling the first HVAC component and the second HVAC component of the HVAC system. The HVAC controller may include a memory for storing a data structure that includes information that associates the first HVAC component with the first EIM and the second HVAC component with the second EIM. The wireless interface of the HVAC controller may be configured to reference the data structure, and based on the data structure, send one or more control commands to the first HVAC component via the first EIM, and one or more control commands to the second HVAC component via the second EIM.

An illustrative method for controlling two or more distributed HVAC components of an HVAC system may include generating one or more first control commands for a first HVAC component of the HVAC system and wirelessly sending the one or more first control commands for the first HVAC component to a wireless interface of a first EIM that may be wired to the first HVAC component. The illustrative method may then generate one or more second control commands for a second HVAC component of the HVAC system and wirelessly send the one or more second control commands for the second HVAC component to a wireless interface of a second EIM that may be wired to a second EIM. In some cases, the first EIM may receive one or more control signals from the wireless interface of the first EIM, generate one or more control commands in response to the one or more control signals, and send the one or more control commands generated in response to the one or more control signals to control the second HVAC component of the HVAC system.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following detailed description of various embodiments in connection with the accompanying drawings, in which:

FIG. 1 is a schematic view of an illustrative HVAC system of a building that includes wireless Equipment Interface Modules (EIM) wired to respective HVAC components;

FIG. 2A is a schematic view of an illustrative HVAC controller;

FIG. 2B is a front view of an illustrative HVAC controller;

FIG. 3 show an illustrative screen that may be displayed on the display of the HVAC controller of FIG. 2B;

FIG. 4 is a schematic view of an illustrative equipment interface module (EIM);

FIG. 5 is a schematic view of an illustrative HVAC system showing the communication links between a building controller, two or more equipment interface modules (EIM), and two or more HVAC components; and

FIG. 6 is a flow chart of an illustrative method for providing commands to two or more HVAC components in an HVAC system.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements throughout the several views. The description and drawings show several examples which are meant to illustrative in nature.

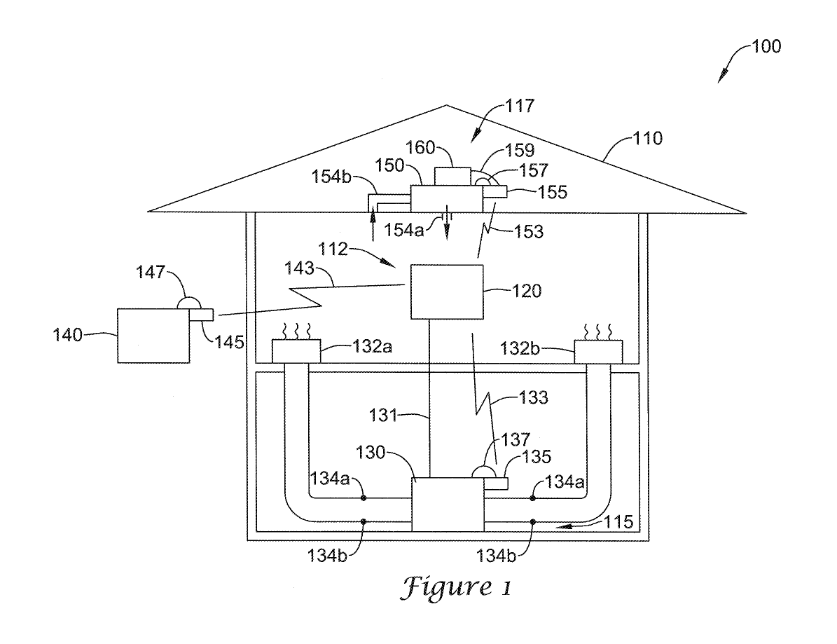

FIG. 1 is a schematic view of an illustrative HVAC system 100 servicing a building or structure 110 including two or more illustrative Equipment Interface Modules (EIM) wired to respective HVAC components. While FIG. 1 shows a typical boiler type HVAC system 100, other types of HVAC systems are contemplated including, but not limited to, forced air systems, radiant heating systems, electric heating systems, cooling systems, heat pump systems, and/or any other type of HVAC system 100, as desired. The illustrative HVAC system 100 may include one or more building controllers 120, such as an HVAC controller (e.g., a thermostat, zone controller, etc.). The building controller 120 may be communicatively coupled to one or more HVAC components of the HVAC system via a communication link (e.g., a wired link 131 or a wireless link 133). The one or more HVAC components may include a boiler 130, a compressor 140, an air handler 150, and/or a humidifier 160, but in other instances may include a furnace, a heat pump, an electric heat pump, a geothermal heat pump, an electric heating unit, an air conditioning unit, a dehumidifier, an air exchanger, an air cleaner, a damper, a valve, and/or the like.

Often, the HVAC components for providing heating, cooling and/or for controlling indoor air quality (IAQ) for at least a zone 112 of the building 110 are located in different areas in and around the building 110. For example, the boiler 130 may be located in a basement 115, the compressor 140 for a heat pump and/or cooling system may be located outside of the building 110, and/or the air handler 150 for the cooling system may be located in the attic 117. In some cases, the building controller 120 may communicate with an HVAC component, such as the boiler 130, using a wired link 131 through one or more physical wires. In some instances, the building controller 120 may include one or more control terminals, each for optionally receiving a control wire connected to an HVAC component of the HVAC system. Often, the one or more control wires may be installed during construction and/or renovation of the building 110. In some cases, the wired link 131 may require maintenance, such as when one or more wires are damaged, or when HVAC components are added to and/or replaced in the HVAC system 100. In some cases, installing new wired links and/or replacing damaged wires may be difficult and/or expensive.

In such cases, one or more wireless EIMs 135, 145, 155 may be installed to allow for communication between the building controller 120 and the one or more HVAC components 130, 140, 150, 160. In some cases, the EIMs 135, 145, 155 may be used for communication between the building controller 120 and the HVAC components 130, 140, 150, 160. For example, the boiler 130 may be communicatively coupled to an EIM 135 via a wired link 137, and the compressor 140 may be communicatively coupled to an EIM 145 via a wired link 147. In some cases, one EIM, such as EIM 150, may be used to allow the building controller 120 to communicate with two or more HVAC components. For example, the EIM 155 may be communicatively coupled to the air handler 150 via the wired link 157 and to the humidifier 160 via the wired link 159.

In the example shown in FIG. 1, the HVAC controller 120 may be configured to control the comfort level in at least one zone 112 of the building or structure 110 by activating and deactivating, or otherwise controlling, the HVAC component(s) 130, 140, 150, 160 in a controlled manner. The HVAC controller 120 may wirelessly communicate with one or more of the HVAC components 130, 140, 150, 160 via the wireless links 133, 145, 153 using one or more of the wireless EIMs 135, 145, 155 following a wireless protocol. Illustrative wireless protocols may include, but are not limited to, cellular communication, ZigBee, Bluetooth, WiFi such as IEEE 802.11, IrDA, dedicated short range communication (DSRC), EnOcean, and/or any other suitable wireless protocols, as desired.

In some cases, the HVAC controller 120 may be a thermostat, such as, for example, a wall mountable thermostat, but this is not required in all embodiments. Such a thermostat may include (e.g. within the thermostat housing) or have access to a temperature sensor for sensing an ambient temperature at or near the thermostat. In some cases, the thermostat may include a base that may allow the thermostat to be mounted on a wall, and a removable housing that may be mounted to the base. The removable housing may include a controller, a communication circuit, a memory, a temperature sensor and a user interface (e.g., a graphical user interface, a manual interface, etc.). In some instances, the HVAC controller 120 may be a zone controller, or may include multiple zone controllers each monitoring and/or controlling the comfort level within one or more zones in the building or other structure 110.

In the example of FIG. 1, the boiler 130 may provide heat to one or more zones within the building 110, such as zone 112, by providing steam to one or more radiant heating element 132A/132B (e.g., a radiator) via one or more pipes 134A/134B. As illustrated, the boiler 130 may be in fluid communication with every room and/or zone in the building 110 via the pipes 134A/134B, but this is not required. To regulate the amount of heat delivered to the space, the thermostat 120 may provide commands to the boiler 130 via the wired link 131. In some cases, the thermostat 120 may provide control commands to the boiler 130 using wireless link 133 to the EIM 135, which may, in turn, provide control commands to the boiler 130 via wired link 137. In operation, when a heat call signal is provided by the HVAC controller 120, the boiler 130 may be activated and/or a valve may be opened to supply a heated fluid to one or more rooms and/or zones within the building 110 via supply pipes 134A. The heated fluid may be forced through supply pipes 134A by a pump (not shown). In this example, the cooler fluid from each zone may be returned to the boiler 130 for heating via return pipes 134B.

In some buildings, one or more additional HVAC components (e.g., the compressor 140, the air handler 150, the humidifier 160, a forced air furnace, an electric heater, an economizer, etc.) may be installed, such as for cooling, for indoor air quality management, for backup heating, for reducing costs, and the like. In the example shown, the HVAC system 100 of building 110 may also include a compressor 140 associated with an air conditioning system and/or a heat pump system, an air handling unit 150 for distributing cooled and/or treated air, and/or a humidifier 160. In some cases, a humidifier 160 may be installed. The HVAC system components, including the boiler 140, the compressor 150, the air handling unit 150 and/or the humidifier 160, may be used together and/or independently to improve indoor air quality and/or manage the comfort level within one or more zones 112 of the building 110.

The air handling unit 150 may be installed in the building 110 as part of a heating, cooling and/or indoor air quality system system of the building 110. The air handling unit 150 may include one or more of a blower (e.g., variable speed, single speed, multiple fans, etc.), a heating element (e.g., gas and/or electric), a filter, and/or a damper. The air handling unit 150 may supply heated and/or treated air into a zone 112 using a supply duct 154A and receive air returned from the zone 112 using a return duct 154B. In some cases, the air handling unit 150 may supply air to and/or receive air from the zone 112 directly (e.g., without using the supply duct 154A and/or the return duct 154B). The air handling unit 150 may include a filter 170 (e.g., HEPA, pleated media, etc.) to remove particulates and/or other contaminants. In some cases, the air handling unit 150 may be configured to control humidification levels for one or more zones 112 of the building 110. For example, the air handling unit 150 may be used to dehumidify (e.g., reduce the relative humidity) of the zone air by using a cooling coil, such as included in the condenser 140, to cool the air to at or below the dew point to cause condensation to occur. In some cases, the air handling unit 150 may then include a re-heat coil to heat the over-cooled air to the desired temperature. In some cases, the air handling unit 150 may be coupled to a humidifier 160 (e.g., an evaporative humidifier, a vaporizer, a spray mist humidifier, an ultrasonic humidifier, a wetted media humidifier, etc.) to improve air quality within at least a portion of the building 110. In some cases, the air handling unit may include a heat recovery device, such as a heat exchanger, to increase capacity and/or reduce costs.

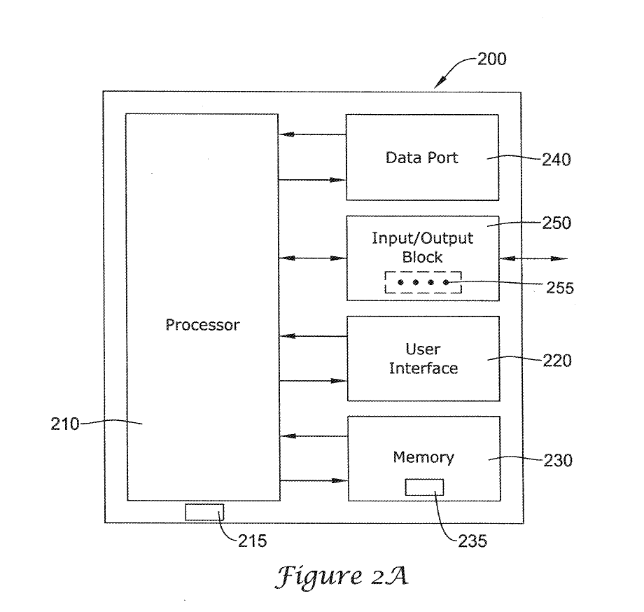

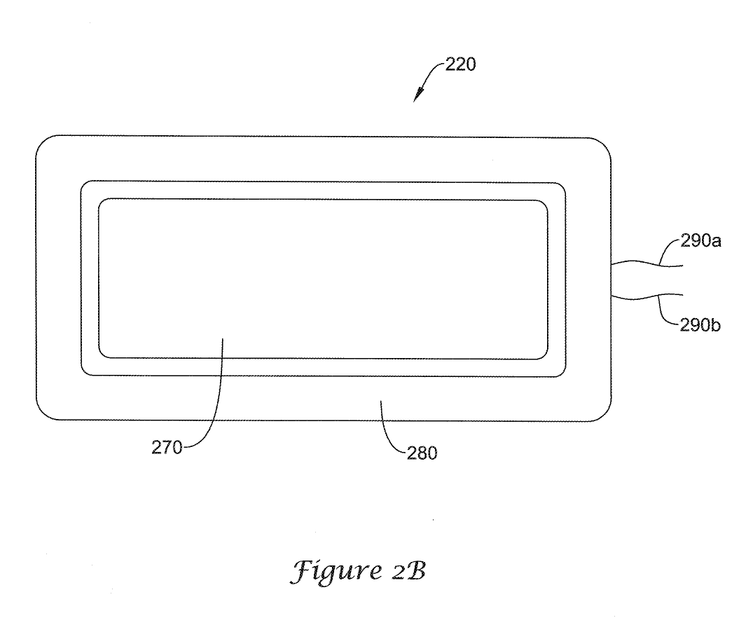

FIG. 2A is a schematic view of an illustrative HVAC controller 200, which may represent the HVAC controller 120 of FIG. 1. In some instances, HVAC controller 200 may be a thermostat and may include a temperature and/or humidity sensor 215, but this is not required. In the illustrative embodiment, the HVAC controller 200 includes a controller (e.g. microprocessor, microcontroller, etc.) 210, a temperature sensor and/or humidity sensor 215, a user interface 220, and a memory 230. In some cases, the controller 210 may include an input/output block (I/O block) 250 for receiving one or more signals from the HVAC system and/or for providing one or more control signals to the HVAC system. For example, the I/O block 250 may communicate with one or more HVAC components 130, 140, 150, 160 of the HVAC system 100. In some cases, the I/O block 250 may communicate with another controller, which is in communication with one or more HVAC components 130, 140, 150, 160 of the HVAC system 100, such as a zone panel in a zoned HVAC system. The I/O block may include one or more control terminals 255 (e.g., input terminals, output terminals, universal terminals, etc.) for optionally interfacing with one or more HVAC components via control wires. The I/O block 250 may also include a wireless interface for wirelessly communicating with one or more wireless devices, such as one or more wireless EIMs. The controller 210 may be coupled to the user interface 220, the memory 230, the temperature sensor 215, and the I/O block 250.

In some cases, the functionality of the inputs and/or output terminals 255 of the I/O block may be fixed or programmable. For instances, the functionality of each of the output terminals 255 may be dedicated to send commands to a specified HVAC component (e.g., IAQ equipment, heating equipment, cooling equipment) and/or the selected functionality of each of the input terminals 255 may be dedicated to receive control signals from a specified HVAC component (e.g., sensors, occupancy information, dry contacts, etc.). In other cases, the functionality of at least some of the inputs/output terminals 255 may be programmable. For example, at least some of the terminals 255 may be “universal” type terminals that may be connected to a variety of different HVAC components, and the functionality of each of these inputs/output terminals 255 may be programmed to support the particularly HVAC components that are ultimately connected to the corresponding universal inputs/outputs in the field.

The controller 210 of the illustrative HVAC controller 200 may operate in accordance with an algorithm that controls or at least partially controls one or more of the HVAC components 130, 140, 150, 160 of an HVAC system such as, for example, HVAC system 100 shown in FIG. 1. The controller 210 may, for example, operate in accordance with an algorithm that uses temperature set points, starting and/or ending times, and the like. In some cases, HVAC controller 200 may include a timer (not shown). The timer may be integral to the controller 210 or may be provided as a separate component.

In the illustrative embodiment of FIG. 2A, the user interface 220 may be any suitable user interface that permits HVAC controller 200 to, for example, display and/or solicit information, as well as accept one or more user interactions from a user. In some cases, the user interface 220 may permit a user to enter data such as temperature set points, humidity set points, starting times, ending times, diagnostic limits, conditions under which diagnostic limits may be suspended, responses to alerts, and the like. In some cases, the user interface 220 may include a display and a distinct keypad. A display may be any suitable display. In some instances, a display may include or may be a liquid crystal display (LCD), and in some cases a fixed segment display or a dot matrix LCD display. If desired, user interface 220 may be a touch screen LCD panel that functions as both display and keypad. In some instances, a touch screen LCD panel may be adapted to solicit values for a number of operating parameters and/or to receive such values, but this is not required.

The memory 230 of the illustrative HVAC controller 200 may be in communication with the controller 210. The memory 230 may be used to store any desired information, such as the aforementioned control algorithm, set points, schedule times, diagnostic limits such as, for example, differential pressure limits, and the like. Also, the memory 230 may be used to store one or more data structures 235 containing information about a configuration of the HVAC system 100. For example, a data structure 235 may be used to store information about the association between one or more of the EIMs 135, 145, 155 and one or more HVAC components 130, 140, 150, 160. For example, the data structure 235 may include association information between a first HVAC component (e.g., the boiler 130) and a first EIM 135, and a second HVAC component (e.g., the compressor 140) and a second EIM 145. In some cases, the data structure 235 may include information about an association with two or more HVAC components (e.g., the air handling unit 150 and the humidifier 160) with a single EIM, such as the EIM 165. The data structure 235 may include information that can be used to issue a command to and/or request information from an EIM. The Memory 230 may be any suitable type of storage device including, but not limited to, RAM, ROM, EPROM, flash memory, a hard drive, and/or the like. In some cases, controller 210 may store information within memory 230, and may subsequently retrieve the stored information during operation.

As illustrated in FIG. 2A, HVAC controller 200 may include a data port 240. Data port 240 may be a wireless port such as a Bluetooth™ port or any other wireless protocol. In other cases, data port 240 may be a wired port such as a serial port, a parallel port, a CATS port, a USB (universal serial bus) port, and/or the like. In some instances, data port 240 may be a USB port and may be used to download and/or upload information from a USB flash drive or some other data source. Other remote devices may also be employed, as desired.

Data port 240 may be configured to communicate with controller 210 and may, if desired, be used to upload information to controller 210 and/or download information from controller 210. Information that can be uploaded and/or downloaded may include, for example, values of operating parameters. In some instances, data port 240 may be used to upload a previously-created thermostat configuration into HVAC controller 200, thereby hastening the programming process. In some cases, data port 240 may be used to download a thermostat configuration that has been created using HVAC controller 200, so that the thermostat configuration may be transferred to other similar thermostats, hastening their programming process. In some cases, data port 240 may be used to upload and/or download information pertaining to an HVAC dealer or contractor, if desired. In some cases, data port 240 may be used to download data stored within the memory 230 for analysis. For example, data port 240 may be used to download a fault and/or alert log or parts thereof to a remote device such as a USB memory stick (also sometimes referred to as a thumb drive or jump drive), personal computer, laptop, iPAD® or other tablet computer, PDA, smart phone, or other remote device, as desired. In some cases, the data may be convertible to an MS EXCEL®, MS WORD®, text, XNL, and/or Adobe PDF® file, but this is not required.

FIG. 2B is a front view of an illustrative HVAC controller, such as the HVAC controller 200. In some cases, the HVAC controller 200 may be configured to provide substantial display and/or programming functionality. In the example shown, the HVAC controller 200 may include a display 270 that is disposed within a housing 280 but viewable externally from the housing 280. In some cases, the display 270 may be a touch screen LCD display. If desired, the display 270 may be a dot matrix touch screen LCD display. A dot matrix touch screen LCD display is a touch screen LCD that permits images such as letters, numbers, graphics, images, and the like to be displayed anywhere on the LCD, rather than being confined to predetermined locations such as is the case with a fixed segment type of LCD display. The housing 280 may be formed of any suitable material, such as a polymeric material. In some cases, the housing 280 may be formed such that it defines a data port 240 (see FIG. 2A). The HVAC controller 200 may also include suitable terminals and/or other electrical connections 290A, 290B, such as the wiring terminals 150, so that the HVAC controller 200 may be optionally electrically coupled to one or more HVAC components of the HVAC system 100.

The HVAC system 100 may include one or more wireless devices that may be configured to communicate and/or interact with the HVAC controller 200 via a wireless communication link (e.g. I/O block 250). Exemplary wireless devices may include, but are not limited to, EIMs, temperature sensors, humidity sensors, gas sensors, another thermostat, a zone control panel, a damper, a valve, and/or any other suitable wireless sensor or device. In many cases, the one or more wireless devices may operate on battery power. In some cases, the one or more wireless devices may have a wired auxiliary source of back-up power in the event of battery failure.

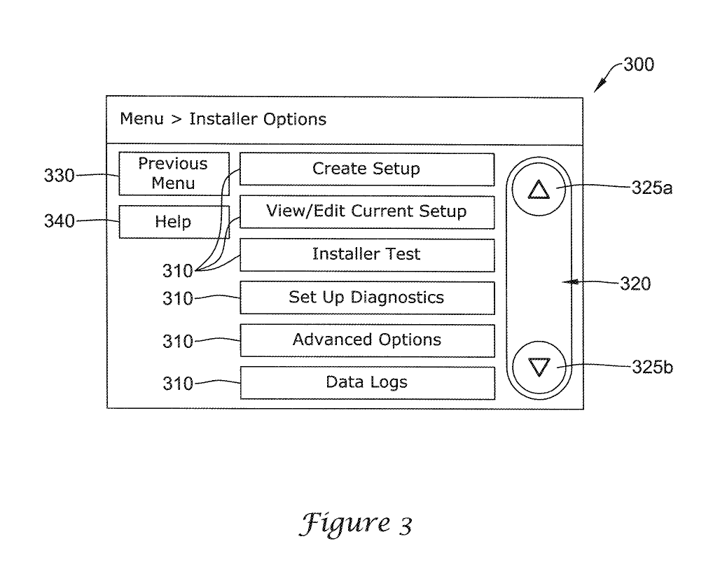

FIG. 3 shows an illustrative screen 300 that may be displayed on the display 270 of the HVAC controller 200. In some cases, the HVAC controller 200 may display one or more menu screens for configuring the HVAC controller 200 to control a particularly HVAC system 100. For example, if a valid password has been entered, the HVAC controller 200 may display an installer options menu screen 300, such as illustrated in FIG. 3. The installer options menu screen 300 may include a table 310 including one or more installer options. In the example shown, an installer may be prompted to enter information about the setup of the HVAC system 100 after selecting the CREATE SETUP option button 315. In some cases, the installer may be prompted to input association information about one or more HVAC components with one or more EIMs (e.g., information about the association of the boiler 130 and EIM 135, the compressor 140 and EIM 145, and/or the air handler 150 and the humidifier and EIM 155). In some cases, the table 310 may be a scrolling table, in which case the installer options menu screen 300 may include a scroll bar 320 having first and second arrows 325A, 325B that may facilitate scrolling through and viewing the available installer options presented in table 310. The installer options menu screen 300 may also include a BACK button or PREVIOUS MENU button 330 which, when selected, may cause another menu screen to be displayed. Additionally, in some cases, the installer options menu screen 300 may include a HELP button 340, which when selected, may cause additional information pertaining to the currently displayed screen to be displayed.

In some cases, the HVAC controller 200 may use the wireless interface of the I/O Block 250 to discover one or more wireless EIM's. A list of discovered EIM's may be displayed on the display 270. In some instances, an installer may accept a connection to at least selected wireless EIM's by selecting the EIM and touching a connect button or the like on the HVAC controller 200. In some cases, the HVAC controller 200 may provide one or more menus that allow an installer to name each EIM (e.g. compressor EIM, furnace EIM, etc.), and/or to set one or more parameters associated with each EIM. The parameters may, for example, specify the type of HVAC component(s) that is connected to each EIM, etc. In some instances, the HVAC controller 200 may provide one or more menus that allow an installer to program the terminals (wire terminals) of the I/O Block 250 and/or specify what HVAC components are wired to the terminals in the particular installation.

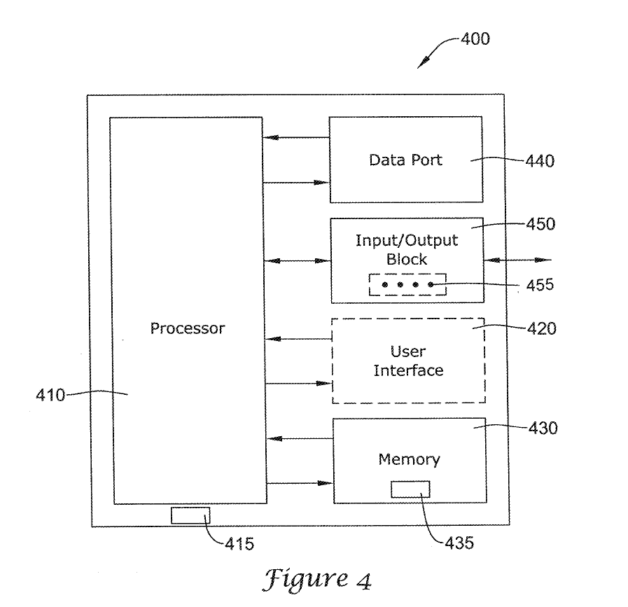

FIG. 4 is a schematic view of an illustrative equipment interface module (EIM) 400, such as the EIM 135, 145, 155 shown in FIG. 1. In some instances, EIM 400 may include a temperature and/or humidity sensor 415, and/or one or more terminals to connect to a sensor external to the EIM 400, but this is not required. In the illustrative embodiment of FIG. 4, the EIM 400 includes a controller (e.g. microprocessor, microcontroller, etc.) 410, an optional temperature sensor and/or humidity sensor 415, an optional user interface 420, and a memory 430. The controller 410 may be coupled to the temperature sensor 415, the memory 430, the user interface 420, and/or the I/O block 450.

In some cases, the input/output block (I/O block) 450 may be for receiving one or more signals and/or for providing one or more signals. In one example, the I/O block 450 may be used to communicate with one or more HVAC components 130, 140, 150, and 160 of the HVAC system 100, sometimes via a wired interface. In some cases, the I/O block 450 may be used to communicate with an HVAC controller 200 of the HVAC system 100 and/or another EIM, sometime via a wireless interface.

The I/O block 450 may include one or more terminals 455 (e.g., input terminals, output terminals, universal terminals, etc.) configured to receive control wires from one or more HVAC components and/or building controllers. In some cases, the assignment of the terminals 455 may be programmable, for example a terminal may be configured either as an input or an output, and/or the functionality of a particular terminal may be programmed. In one example, each of the terminals 455 may be assigned to one or more of the HVAC components and/or building controllers according to the particularly installation, and the functionality of each terminal 455 may depend on a characteristic of the connected devices. For example, one of the wire terminals 455 may be configured as an output, such as when the wire terminal is used to provide a call for heat signal to a furnace, and another one of the wire terminals may be configured as an input when the wire terminal is to be used to receive a sensor signal from a sensor such as a humidity or temperature sensor.

In other cases, the assignment of the terminals 455, or some of the terminals 455, may be fixed. For example, one of the terminals 455 may provide a call for heat signal to a forced air furnace. Another terminal may provide a call for cool, and yet another terminal may provide a call for fan for a forced air furnace. When so provided, and in some cases, a different EIM may be provided depending on the type of HVAC component to be controlled by the EIM.

The controller 410 of the illustrative EIM 400 may operate in accordance with control commands received from an HVAC controller 120, which may control or at least partially controls one or more HVAC components 130, 140, 150, 160 of an HVAC system 100 via the EIM 400. The controller 410 may, for example, receive temperature set points, starting and/or ending times, and the like from the HVAC controller 120, and may communicate the commands to the correct one or more HVAC components 130, 140, 150, 160 associated with the EIM 400. Alternatively, or in addition, the controller 410 may receive commands from an HVAC controller 120, such as a call for heat command, and may pass that command onto the correct one or more HVAC components 130, 140, 150, 160 associated with the EIM 400. In some cases, the controller 410 may include logic that receives a more general commands from an HVAC controller 120 (e.g. turn heat on), and produces control signals that are specific to the particularly HVAC components 130, 140, 150, 160 associated with the EIM 400 (e.g. activate heat pump, but if the outside temperature is too low, activate electric heat). Also, it is contemplated that the EIM 400 may implement interlocks to help ensure proper operation of the HVAC system, as further described below.

In the illustrative embodiment of FIG. 4, the user interface 420 of the EIM 400, when provided, may be any suitable user interface that permits EIM 400 to display and/or solicit information, as well as accept one or more user interactions. For example, the user interface 420 may permit a user to enter data such as information about the one or more associated HVAC components 130, 140, 150, 160, and the like. In some cases, the user interface 420 may include a display and a distinct keypad. A display may be any suitable display. In some instances, a display may include or may be a liquid crystal display (LCD), and in some cases a fixed segment display or a dot matrix LCD display. If desired, user interface 420 may be a touch screen LCD panel that functions as both display and keypad.

The memory 430 of the illustrative EIM 400 may be in communication with the controller 410. The memory 430 may be used to store any desired information, such as the aforementioned communication instructions and information about the associated one or more HVAC components 130, 130, 140, 150, 160. The memory may also store one or more algorithms that may be implemented by EIM 400. In some cases, the controller 410 may operating in accordance with an algorithm that is suitable for controlling the particularly HVAC components that are connected to the EIM 400 in the particular installation at hand.

In some cases, the memory 430 may be used to store one or more data structures 435 containing information about a configuration of the HVAC system 100. For example, a data structure 435 may be used to store information about the association between one or more HVAC components 130, 140, 150, 160 with one or more EIMs 135, 145, 155. In some cases, the data structure 435 may include information to issue a command to and/or request information from an EIM. The memory 430 may be any suitable type of storage device including, but not limited to, RAM, ROM, EPROM, flash memory, a hard drive, and/or the like. In some cases, controller 410 may store information within memory 430, and may subsequently retrieve the stored information. For example, the memory 430 may be used to store a communication log corresponding to messages sent between the HVAC controller 120 and the EIM module 400, fault information and/or alarm information.

In some cases, and as illustrated in FIG. 4, EIM 400 may include a data port 440. Data port 440 may be a wireless port such as a Bluetooth™ port or any other wireless protocol. In other cases, data port 440 may be a wired port such as a serial port, a parallel port, a CATS port, a USB (universal serial bus) port, and/or the like. In some instances, data port 440 may be a USB port and may be used to download and/or upload information from a USB flash drive or some other data source. Other remote devices may also be employed, as desired.

Data port 440 may be configured to communicate with controller 410 and may, if desired, be used to upload information to controller 410 and/or download information from controller 410. Information that can be uploaded and/or downloaded may include, for example, configuration information. In some instances, data port 440 may be used to upload a previously-created EIM configuration into the EIM 400, thereby hastening the configuration process. In some cases, data port 440 may be used to download an EIM configuration that has been created using EIM 400, so that the EIM configuration may be transferred to other similar EIMs, hastening their configuration process. In some cases, data port 440 may be used to download data stored within the memory 430 for analysis. For example, data port 440 may be used to download a fault and/or alert log or parts thereof to a remote device such as a USB memory stick (also sometimes referred to as a thumb drive or jump drive), personal computer, laptop, iPAD® or other tablet computer, PDA, smart phone, or other remote device, as desired. In some cases, the data may be convertible to an MS EXCEL®, MS WORD®, text, XNL, and/or Adobe PDF® file, but this is certainly not required.

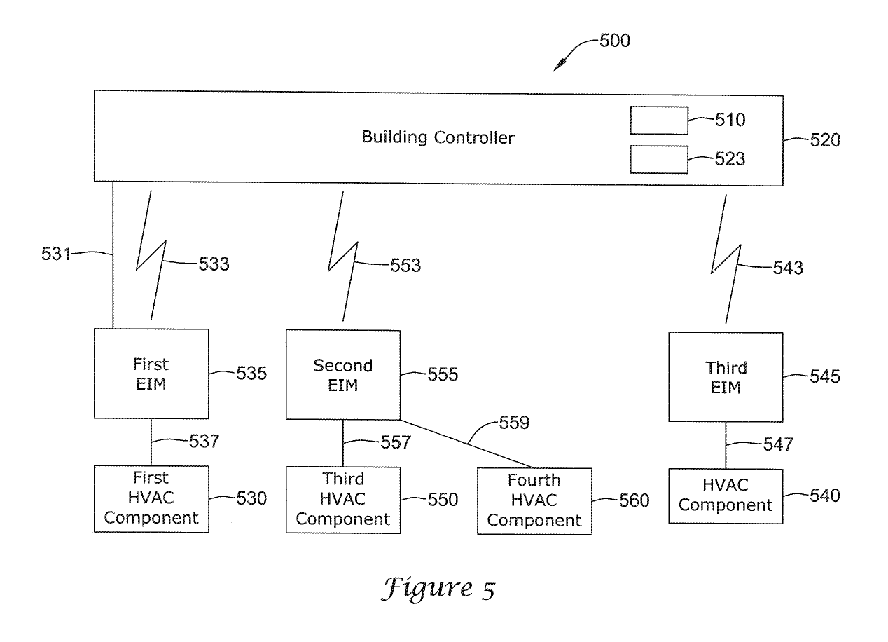

FIG. 5 is a schematic view of an illustrative HVAC system 500 showing communication links between a building controller 520, two or more HVAC components 530, 540, 550, and 560, and two or more intervening Equipment Interface Modules (EIM) 535, 545, and 555. Similar to the HVAC system 100 of FIG. 1, the HVAC system 500 may include one or more wired links 531 and/or wireless links 533, 543, 553 between the building controller 520 and the EIMs 535, 545, and 555. In some cases, the building controller 520 may be a thermostat, a zone controller, and/or any other suitable building controller, as desired. The building controller 520 may be configured to control the comfort levels and/or air quality within one or more zones of a building, such as building 110 of FIG. 1.

In the example shown in FIG. 5, the building controller 520 (e.g., a thermostat, zone controller, etc.) may communicate via a wired link 531 (or the wireless link 533) to a first EIM 535. The first EIM 535, in turn, may be communicatively coupled to a first HVAC component 530 (e.g., a boiler 130) using a communication link, such as wired link 537. Similarly, the building controller 520 may communicate via a wireless link 543 to a second EIM 545 that, in turn, communicates with a second HVAC component (e.g., a compressor 140) using a wired link 547. In some cases, the building controller 520 may communicate with two or more HVAC components using a single EIM. For example, the building controller 520 may communicate with a third EIM 555 using a wireless link 553. The third EIM 555 may communicate with a third HVAC component 550 (e.g., the air handler 150) using a wired link 557 and a fourth HVAC component 560 (e.g., the humidifier 160) using a wired link 559.

In a typical heat-only application, an HVAC component 530 (e.g., the boiler 130, a forced air furnace, and electric heating element, etc.) may communicate directly with a thermostat or other building controller 520 via wired link 531. Sometimes, the HVAC component 530 may communicate with a thermostat using a wireless link 533 via an equipment interface module 535. In some instances, the HVAC system 500 may be upgraded and/or additional HVAC components (e.g., HVAC components 540, 550, 560, etc.) may be added. In some cases, it may be impractical or difficult to add a wired connection to each of the added HVAC components, particularly in a retro-fit scenario. To help reduce the cost of such retro-fits, a wireless link 533, 543, 553 may be used for communicating between the building controller 520 and one or more distributed EIMs 535, 545, 555, which may be located near and be wired to (e.g., via wired links 537, 547, 557, 567) to the one or more HVAC system components 530, 540, 550, 560.

In one example, an HVAC system may be upgraded from single stage cooling to a multi-stage cooling HVAC system. In some cases, it may be difficult to run additional wires from the compressor, located outside of a building, to a building controller within the building. In such cases, the air handler inside of the building may be wired to the building controller, and the multi-stage compressor may be controlled using wireless signals sent from the building controller and an EIM located adjacent and communicatively coupled to the multi-stage compressor outside of the building.

In some cases, the building controller 520 (e.g., thermostat, zone controller, etc.) may include a memory 510 (e.g., memory 230) to store information, such as a data structure 515 for storing association information. The association information stored within the data structure 515 may include one or more of an association of a first HVAC component 530 of the HVAC system with a first equipment interface module (EIM) 535, an association of a second HVAC component 540 with a second EIM 545, an association of a third HVAC component 550 with a third EIM 555. In some cases, the association information can include an association between a fourth HVAC component 560 and one of the first EIM 535, the second EIM 545, or the third EIM 555.

In some cases, the building controller 520 may include a wireless interface 523 for communicating between the building controller 520 and one or more of HVAC components 530, 540, 550, 560 via wireless links 533, 543, 553 and EIMs 535, 545, 555. The building controller 520 may use the wireless interface 523 to send commands to the one or more HVAC components 530, 540, 550, 560 and/or to receive responses back from the HVAC components 530, 540, 550, 560, sometimes via the EIMs 535, 545, 555. In some cases, the building controller 520 may send one or more control signals to an HVAC component via a wired or wireless link, such as to the second HVAC component 540 via EIM 545 and wireless link 543, or to the first HVAC component 530 via EIM 535 and wired link 531. In some cases, the building controller 520 may receive one or more signals from an HVAC component via a wired or wireless link, such as from the second HVAC component 540 via EIM 545 and wireless link 543, or from the first HVAC component 530 via EIM 535 and wired link 531. The building controller 520 may determine one or more control commands, sometimes in response to received signals from the EIMs, such as by using instructions and/or information stored in the memory 510. The building controller 520 may communicate the determined control signals to the appropriate HVAC components (e.g., HVAC component 530, 540, 550, 560).

In some instances, an HVAC system may include two or more HVAC components that work interactively, such as an air handler (e.g., HVAC component 550) and a humidifier (e.g., HVAC component 560), and/or the air handler (e.g., HVAC component 550) and a compressor (e.g., HVAC component 540). The HVAC controller 520 may send a command to an HVAC component, such as a command to reach a specified humidity level to the humidifier 560, or a command for the compressor 540 to operate to reach a specified temperature. In such cases, the HVAC component 540 and/or 560 may send a return signal (e.g., a fan interlock signal) to the HVAC controller 520 to help ensure proper airflow in the HVAC system during operation. The HVAC controller 520 may then communicate a command (e.g., a “fan on” command) to the air handler 550, or other similar component of the HVAC system to command a fan of the HVAC system to turn on. In some instances, the EIMs 535, 545, 555 may communicated directly with one another, and need not communicate through the HVAC controller 520. For example, in the above example, the EIM 545, which is coupled to HVAC component 540, may communicate directly with the EIM 545, which may communicate a fan interlock command (e.g., a “fan on” command) to the air handler 550 to command a fan of the HVAC system to turn on while the HVAC component 540 is activated.

In some cases, one or more of the EIMs 535, 545, 555 may be programmable to include one or more functions based on the functionality of the one or more HVAC components 530, 540, 550, 560 connected to a respective EIM 535, 545, 555. For example, the EIM 545 may be wired to a compressor (e.g., HVAC component 540) and may be programmed to include a defrost control function. The defrost control function may include sending one or more control signals from the EIM 545 to the compressor 540, and another auxiliary heating component (not pictured) to activate a heating element while the compressor is operating in a defrost mode. In some cases, the EIM 545 may send a signal to the HVAC controller 520, which may send a signal to turn on an auxiliary heat either directly or via another EIM, in order to temper the air while the compressor is in the defrost mode. When the defrost input is de-energized at the compressor via EIM 545, the EIM 545 may send a signal to the HVAC controller 520 to turn off the auxiliary heat. In some cases, the instructions and functionality of the EIM 545 may be stored in a memory, such as memory 430, and may be designed to access a data structure 435 that includes information about the control topology of the HVAC components in the HVAC system.

In some cases, an EIM (e.g., the EIM 555) may be configured to communicate to a humidifier (e.g., the HVAC component 560) via a wired link 559. The EIM 555 may be programmed to include a fan interlock function, wherein the fan interlock function includes sending one or more control signals from the EIM 555 to the HVAC controller 520 via the wireless link 553. The HVAC controller 520 may respond by activating a fan of an air handler HVAC component while the humidifier is activated. In some cases, the EIM 555 may be programmed to issue a “fan on” command directly to an air handler (e.g., the HVAC component 550), sometimes via an EIM.

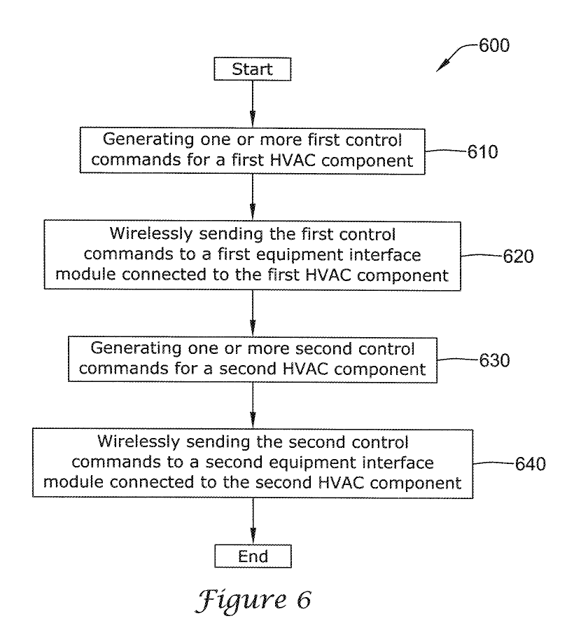

FIG. 6 is a flow chart of an illustrative method 600 for providing commands to two or more HVAC components in an HVAC system. An HVAC controller, such as the illustrative HVAC controllers of FIGS. 1-3, and 5, may be configured to generate one or more first control commands for a first HVAC component of the HVAC system, and one or more second control commands for a second HVAC component. In some cases, the HVAC controller may be configured to generate a control command in response to a control signal received from the one or more HVAC components of the HVAC system, and/or one or more sensors. For example, a control command may be issued in response to temperature, humidity, air quality and/or some other parameter reaching a programmed threshold.

At 610, the HVAC controller generates a first control command for an HVAC component of an HVAC system having two or more HVAC components. At 620, the HVAC controller sends the first control command to the appropriate HVAC component, via a corresponding EIM. At 640, the HVAC controller may generate one or more second control commands for a different one of the one or more HVAC components within the HVAC system. At 650, the HVAC controller may then send the one or more second control commands for the different one of the two or more HVAC components.

In some cases, the HVAC controller may receive a control signal from one of the two or more HVAC components, such as in response to a control command sent to the particular HVAC component. For example, the HVAC controller may receive a control signal from the first HVAC component in response to the command sent to the first HVAC component at 620. The HVAC controller may then process the control signal received from the HVAC component. For example, the first HVAC component may be a humidifier, a compressor, etc., and may send a control signal to enable a fan, such as a fan on an air handling unit. In some cases, the first HVAC component may be a compressor and may send a control signal to enable an auxiliary heating element during a defrost mode. The HVAC controller may then generate a command for one or more different HVAC components in response to the control signal received from the first HVAC component. The HVAC controller may then send the generated command to the different one or more HVAC component via a wired or wireless link to an EIM connected to the desired HVAC component.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made in details, particularly in matters of shape, size, and arrangement of parts without exceeding the scope of the disclosure. The disclosure's scope is, of course, defined in the language in which the appended claims are expressed.

What is claimed is:

1. A thermostat for controlling an HVAC system, the HVAC system having two or more HVAC components and at least two Equipment Interface Modules (EIM), wherein each of the at least two Equipment Interface Modules (EIM) includes a wireless interface and each is wired to a different one of the HVAC components of the HVAC system, the thermostat comprising:
a user interface including a display;
a controller coupled to the user interface, the controller configured to provide one or more control commands to control two or more of the HVAC components of the HVAC system;
two or more control terminals, each for optionally receiving a control wire connected to an HVAC component of the HVAC system; and
a wireless interface coupled to the controller, the wireless interface for sending one or more control commands of the controller to each of two or more HVAC components via the wireless interfaces of the at least two different Equipment Interface Modules (EIM).

2. The thermostat of claim 1, further comprising a memory for storing a data structure that associates a first HVAC component with a first Equipment Interface Module (EIM) and a second HVAC component with a second Equipment Interface Module (EIM).

3. The thermostat of claim 2, wherein the wireless interface references the data structure, and based on the data structure, sends one or more control commands of the controller to the first HVAC component via the first Equipment Interface Module (EIM), and sends one or more control commands of the controller to the second HVAC component via the second Equipment Interface Module (EIM).

4. The thermostat of claim 1, wherein the wireless interface of the thermostat is configured to receive one or more control signals from the wireless interface of at least one of the Equipment Interface Modules (EIM), and the controller is configured to determine one or more control commands in response.

5. The thermostat of claim 4, wherein the wireless interface sends the one or more control commands determined in response to the one or more received control signals to an HVAC component that is wired to another of the Equipment Interface Modules (EIM).

6. The thermostat of claim 4, wherein the thermostat sends the one or more control commands determined in response to the one or more received control signals to an HVAC component via one or more of the control terminals of the thermostat.

7. The thermostat of claim 4, wherein the one or more control signals received from the at least one Equipment Interface Module (EIM) includes a fan interlock signal, and in response, the controller provides a “fan on” command to an air handler HVAC component of the HVAC system.

8. The thermostat of claim 1, wherein each Equipment Interface Modules (EIM) includes one or more terminals for receiving one or more control wires from one or more of the HVAC components of the HVAC system.

9. The thermostat of claim 8, wherein an assignment of at least one of the one or more terminals of at least one of the Equipment Interface Modules (EIM) depends on the one or more HVAC components that are wired to the Equipment Interface Modules (EIM).

10. The thermostat of claim 8, wherein the assignment of at least one of the one or more terminals of at least one of the Equipment Interface Modules (EIM) is programmable.

11. The thermostat of claim 1, wherein at least one of the Equipment Interface Modules (EIM) is programmable to include one or more functions, the one or more functions depending on the one or more HVAC components that are wired to the Equipment Interface Module (EIM).

12. The thermostat of claim 11, wherein when the Equipment Interface Module (EIM) is wired to a compressor that has a defrost mode, the Equipment Interface Module (EIM) is programmed to include a defrost control function, wherein the defrost control function includes sending one or more control signals from the Equipment Interface Modules (EIM) to the wireless interface of the thermostat so that the thermostat responds by activating an auxiliary heat HVAC component while the compressor is in the defrost mode.

13. The thermostat of claim 11, wherein when the Equipment Interface Module (EIM) is wired to a humidifier, the Equipment Interface Module (EIM) is programmed to include a fan interlock function, wherein the fan interlock function includes sending one or more control signals from the Equipment Interface Modules (EIM) to the wireless interface of the thermostat so that the thermostat responds by activating a fan of an air handler HVAC component while the humidifier is activated.

14. A thermostat for controlling two or more HVAC components of an HVAC system, wherein a first HVAC component of the HVAC system is wired to a first Equipment Interface Module (EIM) and a second HVAC component of the HVAC system is wired to a second Equipment Interface Module (EIM), the first Equipment Interface Module (EIM) and the second Equipment Interface Module (EIM) each having a wireless interface, the thermostat comprising:
a user interface including a display;
a controller coupled to the user interface, the controller configured to provide one or more control commands for controlling the first HVAC component and the second HVAC component of the HVAC system;
the controller including a memory for storing a data structure that associates the first HVAC component of the HVAC system with the first Equipment Interface Module (EIM) and associates the second HVAC component of the HVAC system with the second Equipment Interface Module (EIM); and
a wireless interface coupled to the controller, the wireless interface configured to reference the data structure, and based on the data structure, send one or more control commands to the first HVAC component via the first Equipment Interface Module (EIM), and to send one or more control commands to the second HVAC component via the second Equipment Interface Module (EIM).

15. The thermostat of claim 14, further comprising two or more control terminals, each for optionally receiving a control wire from one or more of the HVAC components of the HVAC system.

16. The thermostat of claim 14, wherein the wireless interface of the thermostat is configured to receive one or more control signals from the wireless interface of at least one of the first and second Equipment Interface Modules (EIM), and the controller is configured to determine one or more control commands in response.

17. The thermostat of claim 16, wherein the wireless interface of the thermostat sends the one or more control commands determined in response to the one or more received control signals to an HVAC component that is wired to another of the Equipment Interface Modules (EIM).

18. The thermostat of claim 16, wherein the thermostat sends the one or more control commands determined in response to the one or more received control signals to an HVAC component via one or more control terminals of the thermostat.

19. A method for controlling two or more distributed HVAC components of an HVAC system, the method comprising:
generating one or more first control commands for a first HVAC component of the HVAC system;
wirelessly sending the one or more first control commands for the first HVAC component to a wireless interface of a first Equipment Interface Module (EIM), wherein the first HVAC component is wired to the first Equipment Interface Module (EIM);
generating one or more second control commands for a second HVAC component of the HVAC system;
wirelessly sending the one or more second control commands for the second HVAC component to a wireless interface of a second Equipment Interface Module (EIM), wherein the second HVAC component is wired to the second Equipment Interface Module (EIM).

20. The method of claim 19, further comprising:
receiving one or more control signals from the wireless interface of the first Equipment Interface Modules (EIM);
generating one or more control commands in response to the one or more control signals; and
sending the one or more control commands generated in response to the one or more control signals to control the second HVAC component of the HVAC system.

21. The method of claim 20, wherein the one or more control commands generated in response to the one or more control signals are wirelessly sent to the wireless interface of the second Equipment Interface Module (EIM), and then sent to the second HVAC component.
